(19) United States
(12) Patent Application Publication
(10) Pub. No.: US 2005/0228897 A1
(43) Pub. Date: Oct. 13, 2005

(54) Content distribution system

(76) Inventors: Masaya Yamamoto, Hirakata-shi (JP); Masataka Minami, Arcadia, CA (US); Motoji Ohmori, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/512,719

(22) PCT Filed: Sep. 2, 2003
(86) PCT No.: PCT/JP03/11188

§ 371 Date: Oct. 28, 2004

Related U.S. Application Data
(60) Provisional application No. 60/386,213, filed on Sep. 4, 2002.

(51) Int. Cl. G06F 15/16

(52) U.S. Cl. 709/231

(57) ABSTRACT

The present invention provides a server apparatus that is able to, when a content stored in a server apparatus is to be received with the use of a streaming technique and played back, have the content played back without delay in a network with a low bandwidth. The content stored in the server apparatus is formed with contents data with a high bit rate to be directly played back and contents data with a low bit rate to be played back with the use of the streaming technique. When the content is to be played back directly, the content data with a high bit rate is played back. When the content is to be played back with the use of the streaming technique, the content data with a low bit rate is transmitted.

### TECHNICAL FIELD

The present invention relates to techniques for distributing and playing back contents stored on a recording medium.

### BACKGROUND ART

Optical disks such as CDs and DVDs (Digital Versatile Discs) have already become commonly-used items, and many techniques have been published as regards to next-generation DVDs that have a larger capacity.

Those next-generation DVDs aim at achieving a capacity a number of times larger than the existing DVDs so that visual contents with high resolution can be recorded. In a case where such large-capacity recording media store visual contents with normal resolution such as the ones in NTSC system with use of the MPEG2 compression method and the like, they are able to store contents of much longer hours than the DVDs of the prior art.

Also, a technique called “streaming” has been commonly used lately (for example, see Patent Documentation 1). Streaming is a technique that allows contents to be played back while still in the course of being received, when a user views and listens to contents of video and/or audio over a network. Generally speaking, a system that realizes this technique is structured as a server-client type system, in which the contents stored in a server are sent with use of the streaming technique upon a request from a client, and the client receives and plays back the contents.

Especially, the streaming technique has been tried for applications to home use recently. In such a case, a server machine called a home server is installed at home. The contents stored in the server machine are sent to other client machines at home with use of the streaming technique, and the client machines receive and play back the contents.

The contents to be stored in a home server machine are usually distributed as being broadcasted or being stored in recording media such as optical disks. The contents to be distributed and delivered via broadcasting and recording media are encoded at the highest bit rate possible in order to take advantage of the high band and the large capacity. A generally-used encoding method is MPEG2 which compresses contents with normal resolution such as the ones in NTSC system at a bit rate of 4 to 6 Mbps, and compresses contents with high resolution at a bit rate of around 20 Mbps. Using the highest bit rate possible allows the quality of the compressed images to be high.

The Non-patent Documentation 1 discloses that the streaming server has a function of selecting distribution target contents according to the bandwidth.

Wireless LANs and powerline networks are the more favorable candidates for the home-use networks; however, neither of these networks have enough bandwidth to send, without delay, visual contents compressed by MPEG2. For example, the effective band of the wireless LAN defined by the IEEE802.11b is 3 to 5 Mbps and is not sufficient for transmitting contents compressed by MPEG2.

### PATENT DOCUMENTATION 1

The Japanese Unexamined Patent Application Publication No. 2002-84339

### NON-PATENT DOCUMENTATION 1

http://service.jp.real.com/help/faq/surestream.html

### DISCLOSURE OF THE INVENTION

In order to solve the aforementioned problem, the present invention aims to provide a content distribution system, a server apparatus, a playback apparatus, a content distribution method, and a content distribution program with which it is possible to transmit contents that are suitable for each of the machines connected to a network.

In order to achieve the object, the present invention provides a content distribution system including a server apparatus and a playback apparatus that are connected with each other via a network, wherein (i) the server apparatus comprises: a receiving unit operable to receive a playback request for requesting that a content be played back by one of the server apparatus and the playback apparatus; a judging unit operable to judge which of the server apparatus and the playback apparatus is to play back the content; an obtaining unit operable to,
(a) when the judging unit has judged that the server apparatus is to play back the content, obtain high quality data which is generated by encoding the content so as to render high quality and (b) when the judging unit has judged that the playback apparatus is to play back the content, obtain standard quality data which is generated by encoding the content so as to render standard quality; a first playback unit operable to, when the judging unit has judged that the server apparatus is to play back the content, play back the obtained high quality data; and a transmitting unit operable to, when the judging unit has judged that the playback apparatus is to play back the content, transmit the obtained standard quality data via the network, and (ii) the playback apparatus comprises: a reception unit operable to receive the standard quality data; and a second playback unit operable to decode and play back the received standard quality data.

### BRIEF DESCRIPTION OF THE DRAWINGS

FIG. 1 shows the structure of a content playback system;

FIG. 2 is a block diagram that shows the structure of the management server apparatus 100;

FIG. 3 shows the structure of the data stored in the DVD 270;

FIG. 4 shows the data structure of the table-of-contents file 273;

FIG. 5 the data structure of the compression information file 277;

FIG. 6 is a block diagram that shows the structure of the home server apparatus 200;

FIG. 7 is a block diagram that shows the structure of the personal computer 300;

FIG. 8 is a block diagram that shows the structure of the mobile phone 400;

FIG. 9 is a flow chart that shows the operation for having a content played back by the home server apparatus 200;

FIG. 10 is a flow chart that shows the operation for having a content played back by the personal computer 300;

FIG. 11 is a flow chart that shows the operation for having a content played back by the mobile phone 400, to be continued in FIG. 12;

FIG. 12 is a flow chart that shows the operation for having a content played back by the mobile phone 400, to be continued in FIG. 13; and

FIG. 13 is a flow chart that shows the operation for having content played back by the mobile phone 400, continued from FIG. 12.

### BEST MODE FOR CARRYING OUT THE INVENTION

1. The Content Playback System 1

The following describes the content playback system 1 as an embodiment of the present invention.

1.1 The Structure of the Content Playback System 1

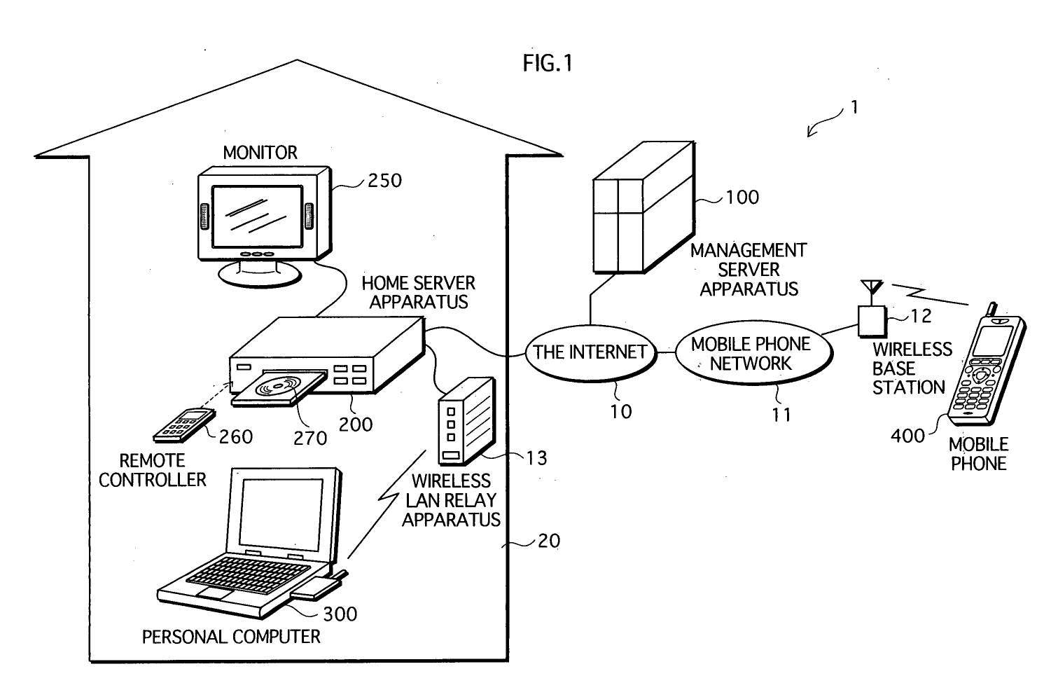

As shown in FIG. 1, the content playback system 1 comprises a management server apparatus 100, a home server apparatus 200, a monitor 250, a wireless LAN relay apparatus 13, a personal computer 300, and a mobile phone 400.

The management server apparatus 100 and the home server apparatus 200 are connected to the Internet 10. The mobile phone 400 is connected to the Internet 10 via the wireless base station 12 and the mobile phone network 11. The home server apparatus 200 and the personal computer 300 are connected with each other via the wireless LAN relay apparatus 13. The communication protocol TCP/IP is used in the communication between the home server apparatus 200 and the personal computer 300.

The home server apparatus 200, the monitor 250, the wireless LAN relay apparatus 13, and the personal computer 300 are installed in the home 20 of a user of these apparatuses.

The user loads a DVD 270, which has a content file and other files recorded thereon, into the home server apparatus 200. The content file is generated by encoding (compression encoding) a content structured with video information and audio information such as a movie. According to a user operation, the home server apparatus 200 reads the content file from the DVD 270 and generates a content by decrypting and decoding the read content file. The home server apparatus 200 then converts the generated content into video and audio signals so that the monitor 250 displays visuals and outputs audio.

According to a user operation, the personal computer 300 obtains, with the use of the streaming technique, a content file suitable for the communication path from the DVD 270 loaded into the home server apparatus 200 via the wireless LAN relay apparatus 13, generates a content by decoding the obtained content file, and converts the generated content into video and audio signals, so as to display visuals and output audio.

According to a user operation, the mobile phone 400 transmits a request for a content to the home server apparatus 200 via the wireless base station 12, the mobile phone network 11, and the Internet 10. The home server apparatus 200 generates a content suitable for the communication path from the loaded DVD 270, encodes the generated content, and generates a content file by further encrypting the content with an encryption key. The home server apparatus 200 then transmits the content file to the mobile phone 400 with the use of the streaming technique via the Internet 10, the mobile phone network 11, and the wireless base station 12. The mobile phone 400 receives the content file from the home server apparatus 200 with the use of the streaming technique, and receives an encryption key from the management server apparatus 100 via the Internet 10, the mobile phone network 11, and the wireless base station 12. The mobile phone 400 then decrypts the content file using the received encryption key, generates a content by further decoding the content file, and converts the generated content into video and audio signals, so as to display visuals and output audio.

1.2 The Management Server Apparatus 100

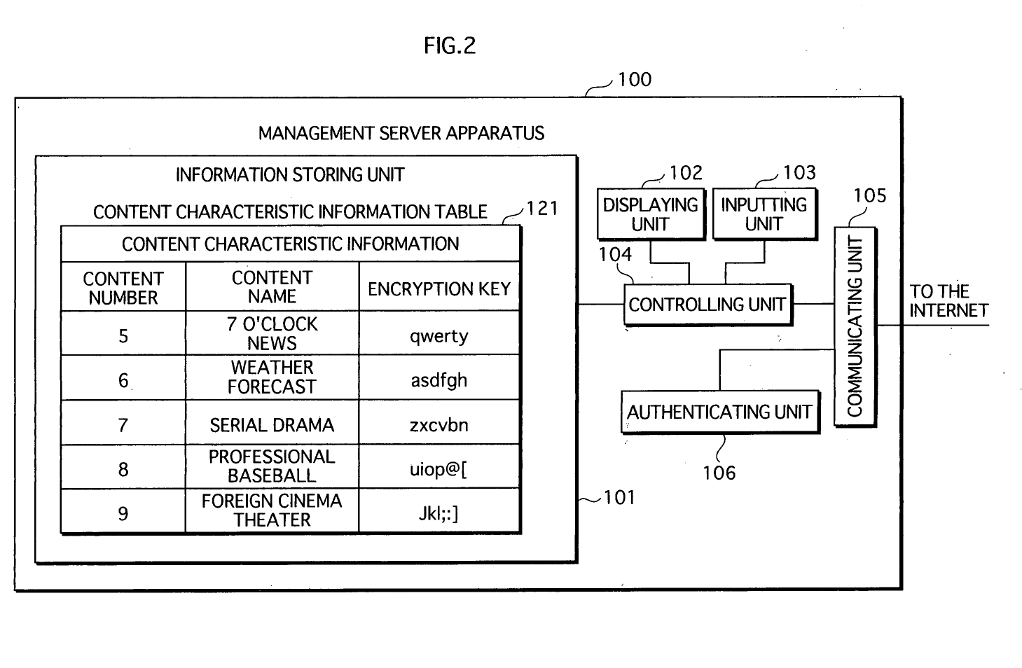

As shown in FIG. 2, the management server apparatus 100 comprises an information storing unit 101, a displaying unit 102, an inputting unit 103, a controlling unit 104, a communicating unit 105, and an authenticating unit 106.

More specifically, the management server apparatus 100 is a computer system structured with a microprocessor, a ROM, a RAM, a hard disk unit, a LAN connection unit, a display unit, a keyboard, a mouse, and the like. A computer program is stored in the RAM or the hard disk unit. When the microprocessor operates according to the computer program, the management server apparatus 100 achieves part of its functions.

(1) The Information Storing Unit 101

As shown in FIG. 2, the information storing unit 101 pre-stores therein a content characteristic information table 121.

The content characteristic information table 121 shows pieces of content characteristic information each including a content number, a content name, and an encryption key. Each “CONTENT NUMBER” is a reference number that uniquely identifies a content. Each “CONTENT NAME” is a name for identifying a content. Each “ENCRYPTION KEY” is a key used to encrypt the content.

(2) The Authenticating Unit 106

Prior to communication between the controlling unit 104 and the mobile phone 400, the authenticating unit 106 performs mutual machine authentication with the mobile phone 400, via the communicating unit 105, the Internet 10, the mobile phone network 11, and the wireless base station 12. Explanation on mutual machine authentication will be omitted since it is publicly known.

When the machine authentication has been successfully performed, the authenticating unit 106 permits the controlling unit 104 to communicate with the mobile phone 400. When the machine authentication has failed, the authenticating unit 106 prohibits the controlling unit 104 from communicating with the mobile phone 400.

(3) The Controlling Unit 104

After the mutual machine authentication between the authenticating unit 106 and the mobile phone 400 has been successfully performed, the controlling unit 104 receives a content number that identifies a content desired by the user from the mobile phone 400, via the wireless base station 12, the mobile phone network 11, the Internet 10, and the communicating unit 105. The controlling unit 104 then reads an encryption key that corresponds to the received content number from the content characteristic information table 121, and transmits the read encryption key to the mobile phone 400 via the communicating unit 105, the Internet 10, the mobile phone network 11, and the wireless base station 12.

(4) The Displaying Unit 102 and the Inputting Unit 103

The displaying unit 102 displays various kinds of information under the control of the controlling unit 104. The inputting unit 103 receives an input of data or an instruction from a user of the management server apparatus 100, and outputs the received data or instruction to the controlling unit 104.

(5) The Communicating Unit 105

The communicating unit 105 performs transmission and reception of information between the authenticating unit 106 and an external device or between the controlling unit 104 and an external device. In this section, the mobile phone 400 is the external device.

1.3 The DVD 270

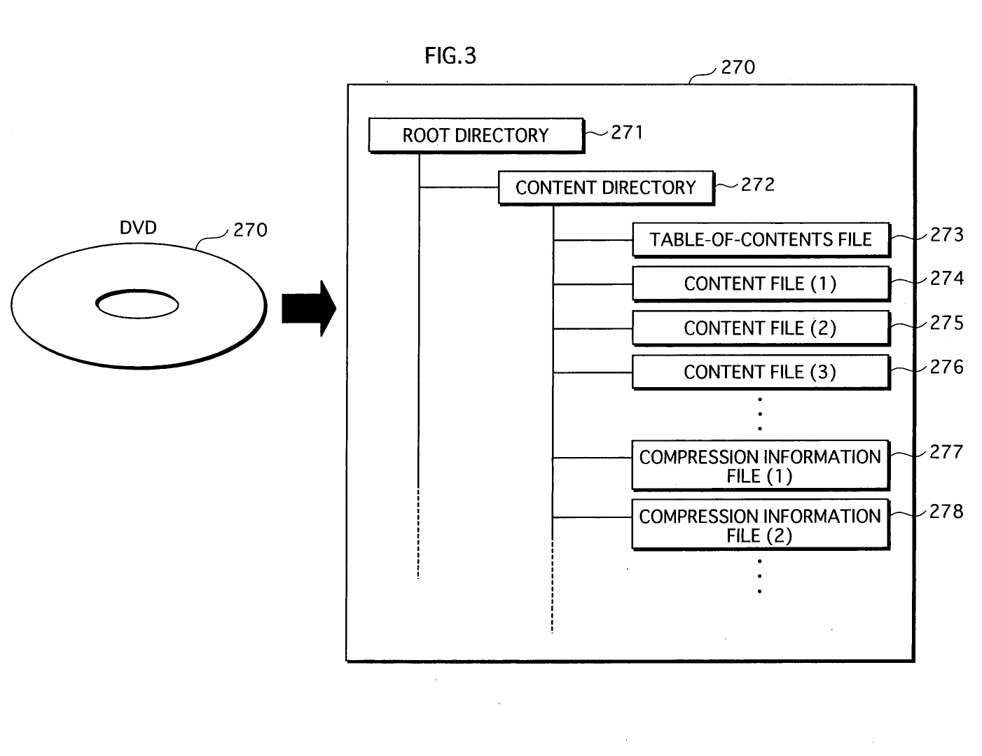

The DVD 270 is an optical disc medium that is able to store therein a large volume of information. FIG. 3 shows the structure of the data stored in the DVD 270.

As shown in FIG. 3, the DVD 270 stores therein files according to a file system to which a tree-like file management structure is applied. In the DVD 270, subordinate to the root directory 271 exists the content directory 272, which is a directory for storing contents. Subordinate to the content directory 272 are stored the table-of-contents file 273, the content files 274, 275, 276, the compression information files 277, 278, and so forth.

In the DVD 270, only one table-of-contents file and as many content files as the number of the contents are stored.

The Table-of-Contents File 273

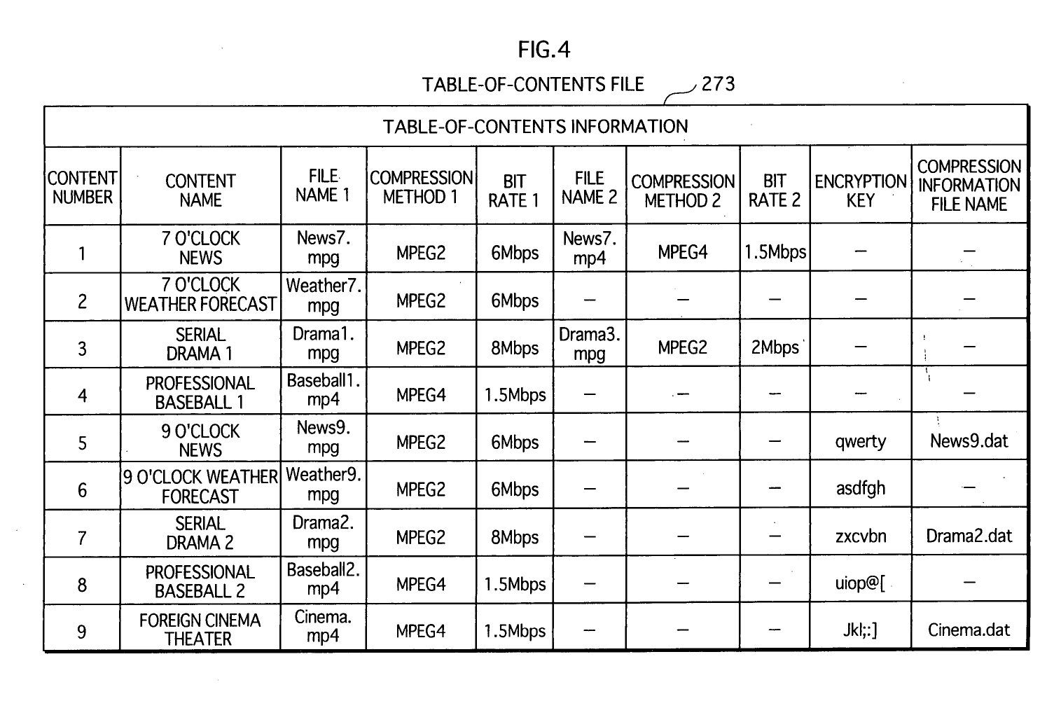

As shown in FIG. 4, the table-of-contents file 273 includes pieces of table-of-contents information, which corresponds to the contents stored in the DVD 270, respectively.

Each piece of table-of-contents information includes a content number, a content name, a file name 1, a compression method 1, a bit rate 1, a file name 2, a compression method 2, a bit rate 2, an encryption key, and a compression information file name.

Each “CONTENT NUMBER” is a reference number that uniquely identifies a content and is used for purposes such as receiving an input from the user when the content is to be played back.

Each “CONTENT NAME” is a name for identifying a content and is used for purposes such as displaying a content list to the user.

Each “FILE NAME 1” is a file name for identifying a content file generated by encoding the content identified with the content number with the use of the compression method 1 and the bit rate 1. The content files identified with each file name 1 exist subordinate to the content directory 272 in the DVD 270.

Each “COMPRESSION METHOD 1” shows a method used to compress the content. Specific examples are “MPEG 2”, “MPEG4”, and the like.

Each “BIT RATE 1” shows the bit rate of the content.

Each “FILE NAME 2” is a file name for identifying a content file generated by encoding the content identified with the content number with the use of the compression method 2 and the bit rate 2. This item is written when, in addition to the content file identified with the file name 1, another content file generated by encoding the same content with the use of the compression method 2 and the bit rate 2 is stored in the DVD 270. In such a case the content file identified with the file name 2 exists subordinate to the content directory 272 in the DVD 270. When such a content file does not exist, nothing is written for this item.

Each “COMPRESSION METHOD 2” shows a method used to compress the content. Specific examples are “MPEG2”, “MPEG4”, and the like. When there is no compression method 2 to be used, nothing is written for this item.

Each “BIT RATE 2” shows the bit rate of the content. When there is no bit rate 2 to be used, nothing is written for this item.

Each “ENCRYPTION KEY” is a key to be used when the content file identified with the file name 1 is generated by encryption. When there is no encryption key to be used, nothing is written for this item.

Each “COMPRESSION INFORMATION FILE NAME” is a file name for identifying a compression information file. When such a compression information file does not exist, nothing is written for this item.

Each set of a content number, a content name, and an encryption key obtained by extracting one or more pieces of information in which an encryption key is written from among the pieces of table-of-contents information included in the table-of-contents file 273 is in correspondence with a different one of the pieces of the content characteristic information stored in the information storing unit 101 in the management server apparatus 100.

The Content Files 274, 275, . . .

The number of the content files 274, 275, . . . is equal to the number of the file names 1 and 2 written in all of the pieces of table-of-contents information included in the table-of-contents file 273. The content files 274, 275, . . . are identified with the file names 1 and 2 written in all of the pieces of table-of-contents information included in the table-of-contents file 273.

The content file 274 corresponds to the piece of table-of-contents information that includes the content number “1” in the table-of-contents file 273. The content file 274 is identified with the file name 1 “News7.mpg” and is structured so as to include compressed encoded data generated by encoding (compression encoding) the content “7 o'clock News” formed with video and audio information with the use of the compression method 1 “MPEG2” and the bit rate 1 “6 Mbps”.

The content file 275 corresponds to the piece of table-of-contents information that includes the content number “1” in the table-of-contents file 273. The content file 275 is identified with the file name 2 “News7.mp4” and is structured so as to include compressed encoded data generated by encoding the content “7 o'clock News” formed with video and audio information with the use of the compression method 2 “MPEG4” and the bit rate 2 “1.5 Mbps”.

The content file 276 corresponds to the piece of table-of-contents information that includes the content number “2” in the table-of-contents file 273. The content file 276 is identified with the file name 1 “Weather7.mpg” and is structured so as to include compressed encoded data generated by encoding the content “7 o'clock Weather Forecast” formed with video and audio information with the use of the compression method 1 “MPEG2” and the bit rate 1 “6 Mbps”.

Another content file corresponds to the piece of table-of-contents information that includes the content number “5” in the table-of-contents file 273. This content file is identified with the file name 1 “News9.mpg” and is structured so as to include compressed encoded data generated by (i) encrypting the content “9 o'clock News” formed with video and audio information with the use of the encryption key “qwerty” according to an encryption algorithm, DES (i.e. Data Encryption Standard), and (ii) further encoding (compression encoding) it with the use of the compression method 1 “MPEG2” and the bit rate 1 “6 Mbps”.

Explanation for other content files will be omitted since they are similar to the above.

The Compression Information Files 277, 278, . . .

The compression information files 277, 278, . . . correspond to the pieces of table-of-contents information that include the content numbers “5”, “6”, “7”, “8”, and “9” in the table-of-contents file 273, respectively.

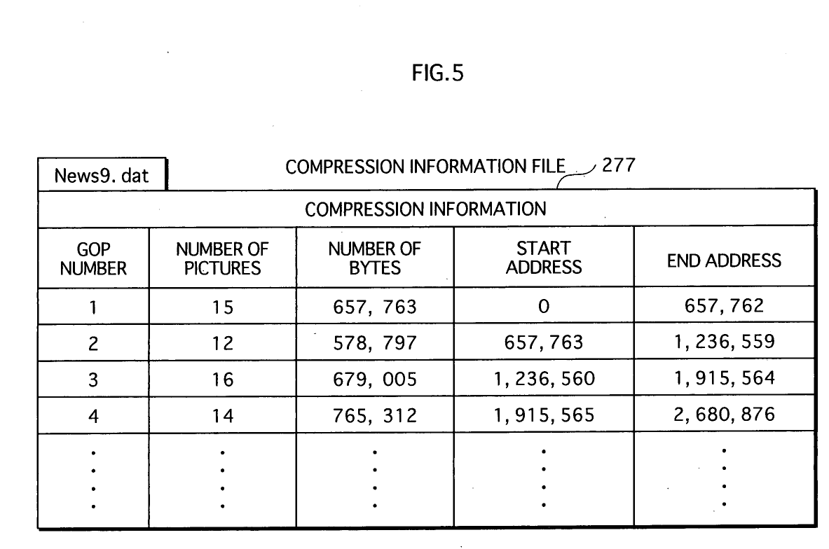

As shown in FIG. 5, the compression information file 277 is structured with pieces of compression information. In compression methods such as MPEG2, a plurality of pictures (frame images) are compressed as a unit. Such a unit is called a GOP (Group of Pictures). Each piece of compression information corresponds to a GOP and includes a GOP number, a number of pictures, a number of bytes, a start address, and an end address.

Each “GOP Number” is a number for identifying a GOP and is assigned to a GOP, starting with “1”.

Each “Number of Pictures” shows how many pictures are included in a GOP identified with the GOP number.

Each “Number of Bytes” shows the total number of bytes of the pictures included in the GOP identified with the GOP number, after the compression.

Each “Start Address” shows the start address of the GOP identified with the GOP number, after the compression. Each address is expressed as a relative position from the beginning of the file.

Each “End Address” shows the end address of the GOP identified with the GOP number, after the compression. Each address is expressed as a relative position from the beginning of the file.

Explanation on other compression information files will be omitted since they are similar to the above.

1.4 The Home Server Apparatus 200

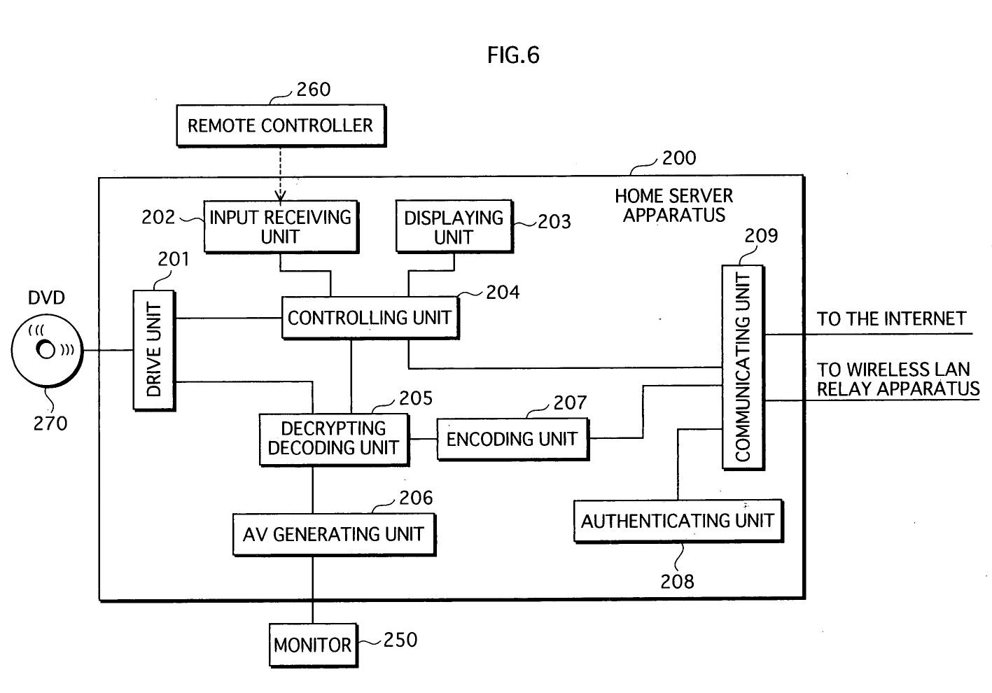

As shown in FIG. 6, the home server apparatus 200 comprises a drive unit 201, an input receiving unit 202, a displaying unit 203, a controlling unit 204, a decrypting decoding unit 205, an AV generating unit 206, an encoding unit 207, an authenticating unit 208, and a communicating unit 209. A monitor 250, which includes a built-in speaker, is connected to the home server apparatus 200. The home server apparatus 200 also receives instruction information outputted by the remote controller 260.

Specifically, the home server apparatus 200 is a computer system structured with a microprocessor, a ROM, a RAM, a hard disk unit, and the like. A computer program is stored in the RAM. When the microprocessor operates according to the computer program, the home server apparatus 200 achieves part of its functions.

(1) The Remote Controller 260, the Input Receiving Unit 202, and the Displaying Unit 203

The remote controller 260 having ten keys, a confirm key, a select key, and the like on the surface thereof, generates instruction information corresponding to each key according to a user operation, and outputs the generated instruction information on an infrared ray.

The input receiving unit 202 receives the infrared ray outputted from the remote controller 260, extracts the instruction information from the received infrared ray, and outputs the extracted instruction information to the controlling unit 204.

The displaying unit 203 displays various kinds of information according to instructions from the controlling unit 204.

(2) The Authenticating Unit 208

Prior to communication between the controlling unit 204 and an external device, the authenticating unit 208 performs mutual machine authentication with the external device. Explanation on mutual machine authentication will be omitted since it is publicly known.

When the machine authentication has been successfully performed, the authenticating unit 208 permits the controlling unit 204 to communicate with the external device. When the machine authentication has failed, the authenticating unit 208 prohibits the controlling unit 204 from communicating with the external device.

In this section, either the personal computer 300 or the mobile phone 400 is the external device.

(3) The Communicating Unit 209

The communicating unit 209 performs transmission and reception of information between the authenticating unit 208 and an external device or between the controlling unit 204 and an external device. In this section, either the personal computer 300 or the mobile phone 400 is the external device.

(4) The Drive Unit 201

Under the control of the controlling unit 204, the drive unit 201 reads information from the DVD 270, and outputs the read information to the controlling unit 204 or the decrypting decoding unit 205.

(5) The Controlling Unit 204

The controlling unit 204 receives a request (a first request) from the remote controller 260 via the input receiving unit 202, the first request requesting that a content list stored in the DVD 270 be displayed. The controlling unit 204 also receives another request (a second request) from the personal computer 300 via the wireless LAN relay apparatus 13 and the communicating unit 209, the second request requesting that a table-of-contents file stored in the DVD 270 be transmitted. The controlling unit 204 also receives another request (a third request) from the mobile phone 400 via the wireless base station 12, the mobile phone network 11, the Internet 10, and the communicating unit 209, the third request requesting that a table-of-contents file stored in the DVD 270 be transmitted.

The controlling unit 204 judges that a request is the first request when it has been received from the input receiving unit 202. The controlling unit 204 judges that a request is either the second or third request when it is received from the communicating unit 209. Further, since the second request and the third request each includes either an identifier indicating a request source or an address in the network indicating a request source, the controlling unit 204 judges whether a request is the second request or the third request using the identifier or the address included in the request.

On a premise that a request has been judged to be one of the first, second, and third requests as explained above, the following describes the processing in each case:

The Processing for Having a Content Played Back by the Home Server Apparatus 200

The controlling unit 204 receives a request from the remote controller 260 via the input receiving unit 202, the request requesting that the content list stored in the DVD 270 be displayed. When receiving the request, the controlling unit 204 reads the table-of-contents file 273 from the DVD 270 via the drive unit 201, extracts all the content numbers and all the content names from the pieces of table-of-contents information included in the table-of-contents file 273, so as to generate a content list from the extracted content numbers and content names. The controlling unit 204 then outputs the generated content list to the displaying unit 203, and controls the displaying unit 203 so that the content list be displayed.

Next, the controlling unit 204 receives one of the content numbers included in the content list from the remote controller 260 via the input receiving unit 202.

Further, the controlling unit 204 judges whether an encryption key is stored in the table-of-contents file 273 in correspondence with the received content number. When having judged that an encryption key is stored, the controlling unit 204 reads the encryption key, and also reads a file name 1 that corresponds to the received content number from the table-of-contents file 273, so as to output the encryption key and the file name 1 to the decrypting decoding unit 205.

When having judged that an encryption key is not stored, the controlling unit 204 reads a file name 1 that corresponds to the received content number from the table-of-contents file 273 so as to output the file name 1 to the decrypting decoding unit 205.

The Processing for Having a Content Played Back by the Personal Computer 300

The controlling unit 204 receives a request from the personal computer 300 via the wireless LAN relay apparatus 13 and the communicating unit 209, the request requesting that the table-of-contents file stored in the DVD 270 be transmitted. When receiving the request, the controlling unit 204 reads the table-of-contents file 273 from the DVD 270 via the drive unit 201, and transmits the read table-of-contents file to the personal computer 300 via the communicating unit 209 and the wireless LAN relay apparatus 13.

Next, the controlling unit 204 receives a file name that identifies a content file desired by the user from the personal computer 300 via the wireless LAN relay apparatus 13 and the communicating unit 209.

Further, the controlling unit 204 reads a content file identified with the received file name from the DVD 270 via the drive unit 201, so as to output the read content file to the personal computer 300 via the communicating unit 209 and the wireless LAN relay apparatus 13 with the use of the streaming technique.

The Processing for Having a Content Played Back by the Mobile Phone 400

The controlling unit 204 receives a request from the mobile phone 400 via the wireless base station 12, the mobile phone network 11, the Internet 10, and the communicating unit 209, the request requesting that the table-of-contents file stored in the DVD 270 be transmitted. When receiving the request, the controlling unit 204 reads the table-of-contents file 273 from the DVD 270 via the drive unit 201, and extracts one or more pieces of table-of-contents information that each include an encryption key, out of the pieces of table-of-contents information included in the read table-of-contents file, so as to transmit, as a table-of-content file that is newly generated, the extracted pieces of table-of-contents information to the mobile phone 400 via the communicating unit 209, the Internet 10, the mobile phone network 11, and the wireless base station 12.

Next, the controlling unit 204 receives a file name 1 that identifies a content file desired by the user and a machine type from the mobile phone 400 via the wireless base station 12, the mobile phone network 11, the Internet 10, and the communicating unit 209. In this case, the machine type indicates that the mobile phone 400 is a mobile phone that performs wireless communication via a mobile phone network. For each machine type, a network band is predetermined. Next, judgment on a network band is made based on the received machine type. Here, for example, since the machine type indicates a mobile phone, it is judged that 3 Mbps is a limit for a band of the mobile phone network to be used. Such a band will be referred to as a limit band.

Further, the controlling unit 204 reads a piece of table-of-contents information that includes the received file name 1 from the table-of-contents file 273, so as to extract the bit rate 1 from the read piece of table-of-contents information.

Next, the controlling unit 204 compares the extracted bit rate 1 with the limit band. When the bit rate 1 does not exceed the limit band, the controlling unit 204 reads a content file identified with the file name 1 and transmits the read content file to the mobile phone 400 via the communicating unit 209, the Internet 10, the mobile phone network 11, and the wireless base station 12, with the use of the streaming technique.

When the bit rate 1 exceeds the limit band, the controlling unit 204 outputs the received file name 1, as well as the encryption key and the compression information file name that are included in the read piece of table-of-contents information to the decryption decoding unit 205. The controlling unit 204 also outputs the encryption key and the compression information file name that are included in the read piece of table-of-contents information to the encoding unit 207.

(6) The Decrypting Decoding Unit 205 the Processing for Having a Content Played Back by the Home Server Apparatus 200

The decrypting decoding unit 205 receives either an encryption key and a file name 1 or a file name 1 from the controlling unit 204.

When having received an encryption key and a file name 1, the decrypting decoding unit 205 reads a content file identified with the received file name 1 from the DVD 270, and generates a decrypted content by decrypting the read content file with the received encryption key. Further, the decrypting decoding unit 205 generates a content by decoding the generated decrypted content and outputs the generated content to the AV generating unit 206.

When having received only a file name 1, that is when having not received an encryption key, the decrypting decoding unit 205 reads a content file identified with the read file name 1 from the DVD 270, and generates a content by decoding the read content file, so as to output the generated content to the AV generating unit 206.

The Processing for Having a Content Played Back by the Mobile Phone 400

The decrypting decoding unit 205 receives a compression information file name, an encryption key, and a file name 1 from the controlling unit 204. The decrypting decoding unit 205 then reads a content file identified with the received file name 1 as well as a compression information file identified with the received compression information file name from the DVD 270, so as to generate a decrypted content by decrypting the read content file using the received encryption key.

Next, the decrypting decoding unit 205 generates a content by decoding the generated content with the use of the compression information file, and outputs the generated content to the encoding unit 207. More specifically, for the generated decrypted content, the decrypting decoding unit 205 (a) specifies a GOP after the compression according to the start address and the end address included in the compression information file, (b) generates a plurality of pictures by decoding the specified GOP after the compression by, for example, MPEG2, and (c) outputs the generated plurality of pictures to the encoding unit 207. The decrypting decoding unit 205 repeats (a), (b), and (c) for each of the GOPs after the compression that are included in the decrypted content.

(7) The Encoding Unit 207

The encoding unit 207 receives a content from the decrypting decoding unit 205 and receives a compression information file and an encryption key from the controlling unit 204. The encoding unit 207 then reads a compression information file identified with the received compression information file name from the DVD 270.

Next, the encoding unit 207 generates a reduced content by reducing the received content using the GOP number, the number of pictures, the number of bytes, the start address, and the end address included in the read compression information file, encodes the generated reduced content, and further generate a content file by performing encryption with the received encryption key. More specifically, the encoding unit 207 (a) generates a plurality of reduced pictures by reducing, with a predetermined ratio, each of the plurality of pictures received from the decrypting decoding unit 205, and (b) generates encoded pictures by encoding again the generated plurality of reduced pictures by, for example, MPEG2. The encoding unit 207 repeats (a) and (b) for each of the plurality of pictures received from the decrypting decoding unit 205.

Next the encoding unit 207 transmits the generated content file to the mobile phone 400 via the communicating unit 209, the Internet 10, the mobile phone network 11, and the wireless base station 12, with the use of the streaming technique.

(8) The AV Generating Unit 206 and the Monitor 250

The AV generating unit 206 receives a content from the decrypting decoding unit 205, separates the received content into video information and audio information, and further converts them into video signals and audio signals respectively, so as to output the generated video signals and audio signals to the monitor 250.

The monitor 250 receives the video signals and audio signals, and displays visuals based on the received video signals as well as outputs audio based on the received audio signals.

1.5 The Wireless LAN Relay Apparatus 13

The wireless LAN relay apparatus 13 is connected with the home server apparatus 200 via a cable. The wireless LAN relay apparatus 13 also conforms to the IEEE802.11b and communicates with the personal computer 300 by way of wireless communication with a 2.4 GHz band at a communication speed of 3 to 5 Mbps as an effective band. With this arrangement, the wireless LAN relay apparatus 13 relays the communication between the home server apparatus 200 and the personal computer 300.

1.6 The Personal Computer 300

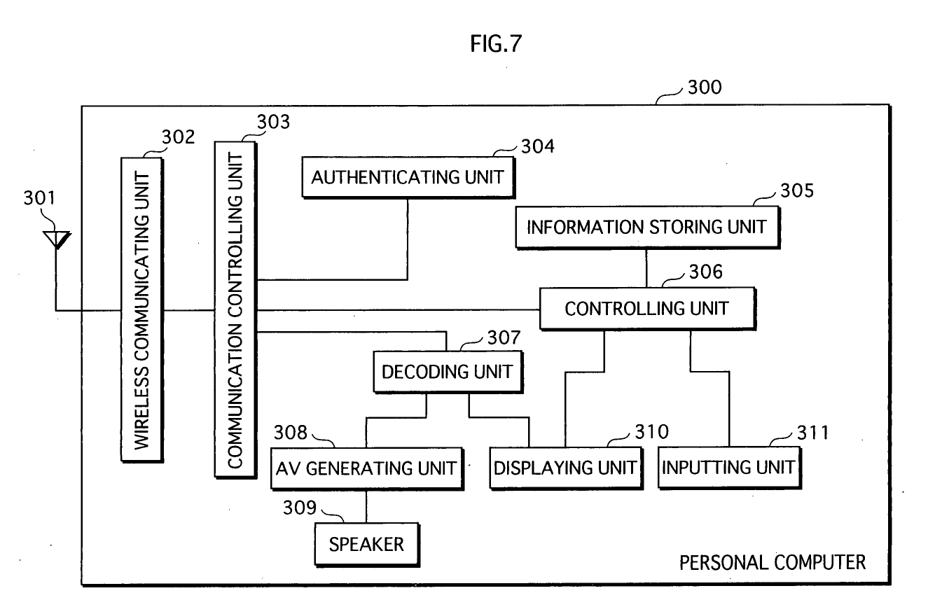

As shown in the functional block diagram in FIG. 7, the personal computer 300 comprises an antenna 301, a wireless communicating unit 302, a communication controlling unit 303, an authenticating unit 304, an information storing unit 305, a controlling unit 306, a decoding unit 307, an AV generating unit 308, a speaker 309, a displaying unit 310, and an inputting unit 311.

More specifically, the personal computer 300 is a computer system structured with a microprocessor, a ROM, a RAM, a hard disk unit, a liquid crystal display unit, a keyboard, a wireless communicating unit, and the like. A computer program is stored in the RAM or the hard disk unit. When the microprocessor operates according to the computer program, the personal computer 300 achieves part of its functions.

(1) The Information Storing Unit 305

The information storing unit 305 pre-stores therein a limit band for the communication between the home server apparatus 200 and the personal computer 300 via the wireless LAN relay apparatus 13.

(2) The Antenna 301, the Wireless Communicating Unit 302, and the Communication Controlling Unit 303

The antenna 301, the wireless communicating unit 302, and the communication controlling unit 303 perform transmission and reception of information with the wireless LAN relay apparatus 13 by way of wireless communication with a 2.4 GHz frequency band.

The wireless communicating unit 302 includes a transmitting/receiving unit that is operable to transmit and receive signals via the antenna 301 and a modulating/demodulating unit that is operable to modulate and demodulate the signals. The communication controlling unit 303 processes various signals that are inputted and outputted between the wireless communicating unit 302 and the communication controlling unit 303. The communication controlling unit 303 also establishes a communication channel for short-distance wireless communication between the wireless LAN relay apparatus 13 and the communication controlling unit 303, and performs communication using the established communication channel.

(3) The Authenticating Unit 304

Prior to communication between the controlling unit 306 and an external device, the authenticating unit 304 performs mutual machine authentication with the external device. Explanation on mutual machine authentication will be omitted since it is publicly known.

When the machine authentication has been successfully performed, the authenticating unit 304 permits the controlling unit 306 to communicate with the external device. When the machine authentication has failed, the authenticating unit 304 prohibits the controlling unit 306 from communicating with the external device.

In this section, the home server apparatus 200 is the external device.

(4) The Controlling Unit 306

The controlling unit 306 reads a limit band from the information storing unit 305.

Then, the controlling unit 306 receives a request from the inputting unit 311, the request requesting that a table-of-content file be transmitted. The controlling unit 306 then transmits the request to the home server apparatus 200 via the communication controlling unit 303, the wireless communicating unit 302, the antenna 301, and the wireless LAN relay apparatus 13.

Next, the controlling unit 306 receives the table-of-contents file from the home server apparatus 200 via the wireless LAN relay apparatus 13, the antenna 301, the wireless communicating unit 302, and the communication controlling unit 303, extracts one or more pieces of table-of-contents information that each do not include an encryption key out of the pieces of table-of-contents information included in the table-of-contents file, and further extracts one or more pieces of table-of-contents information that each include either a bit rate 1 or a bit rate 2 that does not exceed the read limit band, out of the extracted pieces of table-of-contents information. Thus, the controlling unit 306 generates a terminal-specific table-of-contents file from the extracted pieces of table-of-contents information.

For example, in a case where 3 Mbps is the limit of the band for the home network being used, one or more pieces of table-of-contents information whose bit rate is 3 Mbps or lower will be selected. For the example shown in FIG. 4, the contents with the content numbers “1”, “3”, and “4” will be selected. The reason is that the bit rate 2 of the content number “1” is “1.5 Mbps”, the bit rate 2 of the content number “3” is “2 Mbps”, and the bit rate 1 of the content number “4” is “1.5 Mbps”.

This is how the contents to be displayed in a content list are selected from the received table-of-contents file.

In the explanation above, limit bands, in other words, bit rates are used for making the selection; however, it is also acceptable to use compression methods recorded in the table-of-contents file. For example, when the personal computer 300 is a machine that conforms only to the MPEG 4 method, such contents that each have “MPEG4” written for the compression method would be selected.

For the example shown in FIG. 4, only the content “7 o'clock News” with the content number “1” and the content “Professional Baseball 1” with the content number “4” would be selected.

The controlling unit 306 extracts content numbers and content names from the pieces of table-of-contents information included in the generated terminal-specific table-of-contents file so as to generate a content list. The controlling unit 306 then outputs the generated content list to the displaying unit 310, and controls the displaying unit 310 so that the content list be displayed.

Next, the controlling unit 306 receives a content number that identifies a content selected by the user from the inputting unit 311, and extracts a piece of table-of-contents information that includes the received content number from the terminal-specific table-of-contents file. When the extracted piece of table-of-contents information has both a file name 1 and a file name 2 written, a bit rate that does not exceed the limit band is selected out of the bit rate 1 and the bit rate 2, and a file name that corresponds to the selected bit rate is extracted. When the extracted piece of table-of-contents information has only a file name 1, and if the bit rate 1 does not exceed the limit band, the file name 1 will be selected as the file name. After a file name has been extracted this way, the controlling unit 306 transmits the extracted file name to the home server apparatus 200 via the communication controlling unit 303, the wireless communicating unit 302, the antenna 301, and the wireless LAN relay apparatus 13.

(4) The Decoding Unit 307

The decoding unit 307 receives a content file from the home server apparatus 200 via the wireless LAN relay apparatus 13, the antenna 301, the wireless communicating unit 302, and the communication controlling unit 303 with the use of the streaming technique, and generates a content by decoding the received content file, so as to output the generated content to the AV generating unit 308.

(5) The AV Generating Unit 308

The AV generating unit 308 receives a content from the decoding unit 307, and separates the received content into video information and audio information, and further converts them into video signals and audio signals respectively, so as to output the generated video signals and audio signals to the displaying unit 310 and the speaker 309, respectively.

(6) The Speaker 309, the Displaying Unit 310, and the Inputting Unit 311

The displaying unit 310 receives video signals and displays visuals according to the received video signals. The displaying unit 310 displays various kinds of information under the control of the controlling unit 306.

The speaker 309 receives audio signals and outputs audio according to the received audio signals.

The inputting unit 311 receives an input of an instruction or data from a user of the personal computer 300, and outputs the received instruction or data to the controlling unit 306.

1.7 The Mobile Phone 400

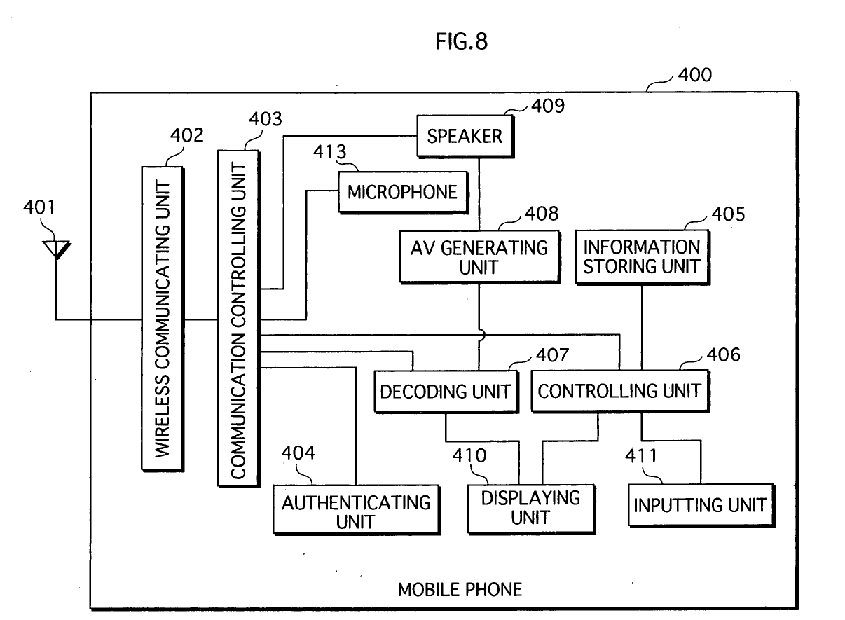

As shown in FIG. 8, the mobile phone 400 comprises an antenna 401, a wireless communicating unit 402, a communication controlling unit 403, an authenticating unit 404, an information storing unit 405, a controlling unit 406, a decoding unit 407, an AV generating unit 408, a speaker 409, a displaying unit 410, an inputting unit 411, and a microphone 413.

More specifically, the mobile phone 400 is a computer system structured with a microprocessor, a signal processor, a ROM, a RAM, and the like. A computer program is stored in the RAM. When the microprocessor and the signal processor operate according to the computer program, the mobile phone 400 achieves part of its functions.

(1) The Information Storing Unit 405

The information storing unit 405 pre-stores therein the machine type. As explained above, the machine type indicates that the mobile phone 400 is a mobile phone that performs wireless communication via a mobile phone network.

(2) The Antenna 401, the Wireless Communicating Unit 402, the Communication Controlling Unit 403

The antenna 401, the wireless communicating unit 402, and the communication controlling unit 403 perform transmission and reception of audio and other information with another apparatus connected thereto, via the wireless base station 12 and the mobile phone network 11.

The wireless communicating unit 402 has a receiving unit and a transmitting unit. The receiving unit includes a high-frequency amplifier, a reception mixer, an IF amplifier, a demodulator, and the like, and amplifies and demodulates signals received by the antenna 401. The transmitting unit includes a transmission power amplifier, a transmission mixer, a modulator, and the like, and modulates high-frequency signals with base band signals, converts them into ones having wireless frequency, amplifies them, and outputs them by the antenna 401. The communication controlling unit 403 has a base band unit and processes various kinds of signals inputted and outputted between the wireless communicating unit 402 and the communication controlling unit 403.

(3) The Authenticating Unit 404

Prior to communication between the controlling unit 406 and an external device, the authenticating unit 404 performs mutual machine authentication with the external device. Explanation on mutual machine authentication will be omitted since it is publicly known.

When the machine authentication has been successfully performed, the authenticating unit 404 permits the controlling unit 406 to communicate with the external device. When the machine authentication has failed, the authenticating unit 404 prohibits the controlling unit 406 from communicating with the external device.

In this section, either the home server apparatus 200 or the management server apparatus 100 is the external device.

(4) The Controlling Unit 406

The controlling unit 406 stores therein a limit band for the communication via the mobile phone network 11.

The controlling unit 406 receives a request resulting from a user operation from the inputting unit 411, the request requesting that a table-of-content file be transmitted, and transmits the request to the home server apparatus 200 via the communication controlling unit 403, the wireless communicating unit 402, the antenna 401, the wireless base station 12, the mobile phone network 11, and the Internet 10.

Next, the controlling unit 406 receives the table-of-contents file from the home server apparatus 200 via the Internet 10, the mobile phone network 11, the wireless base station 12, the antenna 401, the wireless communicating unit 402, and the communication controlling unit 403. The controlling unit 406 then extracts one or more pieces of table-of-contents information whose bit rate 1 does not exceed the read limit band, out of the pieces of table-of-contents information included in the table-of-contents file. Thus, the controlling unit 406 generates a terminal-specific table-of-contents file from the extracted pieces of table-of-contents information.

More specifically, the controlling unit 406 uses the items listed under the bit rate 1 and the compression information file name that are recorded in the received table-of-contents file.

For example, in a case where 3 Mbps is the limit of the band for the home network being used, one or more pieces of table-of-contents information whose bit rate 1 is 3 Mbps or lower will be selected. For the example shown in FIG. 4, two contents such as the content “Professional Baseball 2” with the content number “8” and the content “Foreign Cinema Theater” with the content number “9” will be selected. It is because the bit rate 1 is “1.5 Mbps” in both cases. The controlling unit 406 further selects one or more contents for each of which a compression information file exists, in addition to the contents selected according to the bit rate 1. For the example shown in FIG. 4, the content “9 o'clock News” with the content number “5” and the content “Serial Drama 2” with the content number “7” will be selected. It is because these each have a compression information file name written. It should be noted that the content “Foreign Cinema Theater” with the content number “9” will be also selected, needless to say, since it satisfies both of the criteria for the selection.

Even if the bit rate exceeds the band of the network being used, a content can be selected as the one to be displayed in the content list as long as it has a compression information file. The reason is that it is possible to re-generate a content data that satisfies the bit rate criterion by decrypting, decoding, and further re-encoding a content. Each of the compression information files is used in order to perform such decoding and re-encoding in a smooth manner.

Next, the controlling unit 406 extracts content numbers and content names from the pieces of table-of-contents information included in the generated terminal-specific table-of-contents file so as to generate a content list. The controlling unit 406 then outputs the generated content list to the displaying unit 410, and controls the displaying unit 410 so that the content list be displayed.

Further, the controlling unit 406 receives a content number that identifies a content selected by the user from the inputting unit 411, extracts a piece of table-of-contents information that includes the received content number from the terminal-specific table-of-contents file, and further extracts the file name 1 from the extracted piece of table-of-contents information.

The controlling unit 406 transmits the received content number to the management server apparatus 100 via the communication controlling unit 403, the wireless communicating unit 402, the antenna 401, the wireless base station 12, the mobile phone network 11, and the Internet 10.

In addition, the controlling unit 406 reads the machine type from the information storing unit 405, and transmits the read machine type and the extracted file name 1 to the home server apparatus 200, via the communication controlling unit 403, the wireless communicating unit 402, the antenna 401, the wireless base station 12, the mobile phone network 11, and the Internet 10.

(4) The Decoding Unit 407

The decoding unit 407 receives an encryption key from the management server apparatus 100 via the Internet 10, the mobile phone network 11, the wireless base station 12, the antenna 401, the wireless communicating unit 402, and the communication controlling unit 403. The decoding unit 407 also receives a content file from the home server apparatus 200 via the Internet 10, the mobile phone network 11, the wireless base station 12, the antenna 401, the wireless communicating unit 402, and the communication controlling unit 403.

The decoding unit 407 generates a decrypted content by decrypting the content file using the received encryption key, generates a content by decoding the generated decrypted content, and outputs the generated content to the AV generating unit 408.

(5) The AV Generating Unit 408

The AV generating unit 408 receives a content from the decoding unit 407, and separates the received content into video information and audio information, and further converts them into video signals and audio signals respectively, so as to output the generated video signals and audio signals to the displaying unit 410 and the speaker 409, respectively.

(6) The Speaker 409, the Displaying Unit 410, and the Inputting Unit 411

The displaying unit 410 receives video signals and displays visuals according to the received video signals. The displaying unit 410 displays various kinds of information under the control of the controlling unit 406.

The speaker 409 receives audio signals and outputs audio according to the received audio signals.

The inputting unit 411 receives an input of an instruction or data from a user of the mobile phone 400, and outputs the received instruction or data to the controlling unit 406.

2. The Operations of the Content Playback System 1

The following explains operations of the content playback system 1 for each case of having a content played back by the home server apparatus 200, the personal computer 300, and the mobile phone 400

(1) The Operation for Having a Content Played Back by the Home Server Apparatus 200

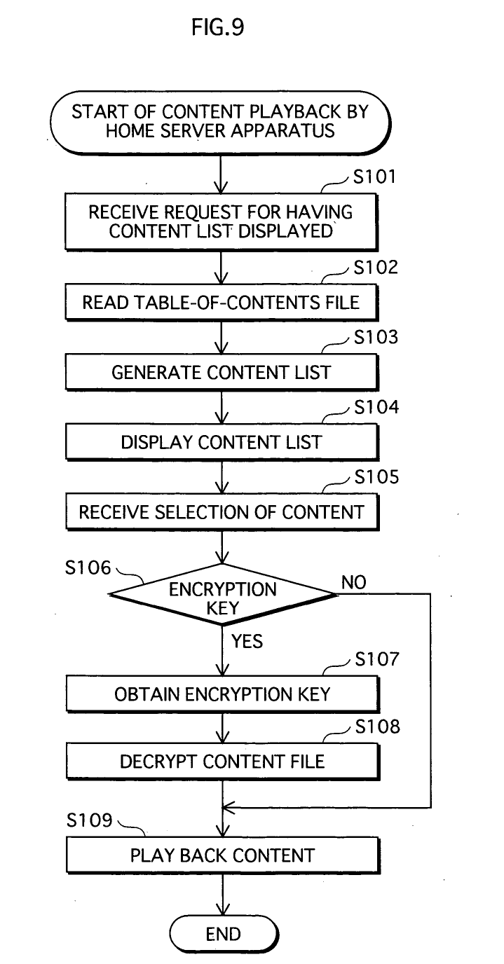

The following describes the operation for having a content played back by the home server apparatus 200, with reference to the flow chart shown in FIG. 9.

The controlling unit 204 of the home server apparatus 200 receives a request from the remote controller 260 via the input receiving unit 202, the request requesting that a content list be displayed (Step S101), reads the table-of-contents file 273 from the DVD 270 (Step S102), and generates a content list (Step S103), and the displaying unit 203 displays the content list (Step S104).

Next, the controlling unit 204 receives a content number included in the content list from the remote controller 260 via the input receiving unit 202 (Step S105).

Further, the controlling unit 204 judges whether an encryption key is stored in the table-of-contents file 273 in correspondence with the received content number. When having been judged that an encryption key is stored (Step S106), the controlling unit 204 reads the encryption key (Step S107). The decrypting decoding unit 205 generates a decrypted content by decrypting the read content file using the encryption key, and further generates a content by decoding the decrypted content (Step S108). The AV generating unit 206 generates video signals and audio signals from the content, and the monitor 250 displays visuals and outputs audio (Step S109).

When the controlling unit 204 has judged that an encryption key is not stored (Step S106), the AV generating unit 206 generates video signals and audio signals from the content, and the monitor 250 displays visuals and outputs audio (Step S109).

(2) The Operation for Having a Content Played Back by the Personal Computer 300

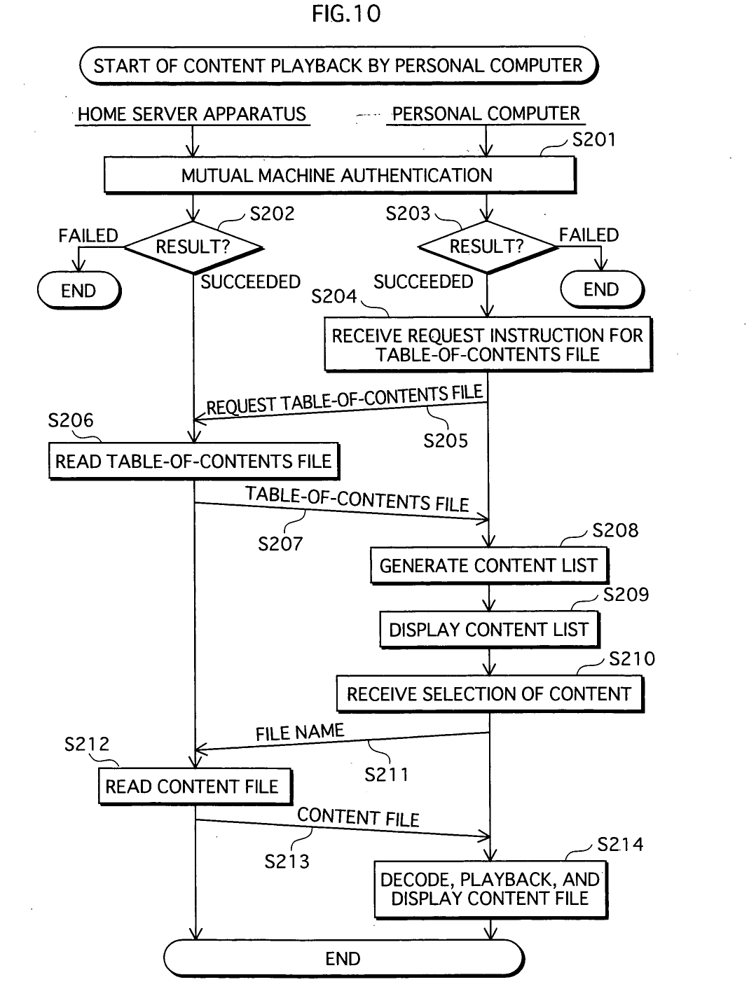

The following describes the operation for having a content played back by the personal computer 300, with reference to the flow chart shown in FIG. 10.

The authenticating unit 208 in the home server apparatus 200 and the authenticating unit 304 in the personal computer 300 perform machine authentication with each other (Step S201).

When the machine authentication has failed (Step S202, Step S203), the home server apparatus 200 and the personal computer 300 cancel the processing thereafter.

When the machine authentication has been successfully performed (Step S202, Step S203), the controlling unit 306 receives, from the inputting unit 311, a request requesting that a table-of-contents file be transmitted (Step S204), and transmits the request to the home server apparatus 200 via the communication controlling unit 303, the wireless communicating unit 302, the antenna 301, and the wireless LAN relay apparatus 13 (Step S205).

The controlling unit 204 reads the table-of-contents file 273 from the DVD 270 via the drive unit 201 (Step S206), and transmits the read table-of-contents file to the personal computer 300 via the communicating unit 209 and the wireless LAN relay apparatus 13 (Step S207).

Next, the controlling unit 306 generates a content list using the received table-of-contents file (Step S208). The displaying unit 310 displays the content list (Step S209). The controlling unit 306 receives a content number that identifies a content selected by the user from the inputting unit 311, extracts a file name that corresponds to the received content number from the table-of-contents file (Step S210), and transmits the extracted file name to the home server apparatus 200 via the communication controlling unit 303, the wireless communicating unit 302, the antenna 301, and the wireless LAN relay apparatus 13 (Step S211).

The controlling unit 204 reads a content file identified with the received file name from the DVD 270 via the drive unit 201 (Step S212), and outputs the read content file to the personal compute 300 via the communicating unit 209 and the wireless LAN relay apparatus 13, with the use of the streaming technique (Step S213).

The decoding unit 307 receives the content file from the home server apparatus 200 with the use of the streaming technique, and generates a content. The AV generating unit 308 generates video signals and audio signals. The displaying unit 310 displays visuals, and the speaker 309 outputs audio (Step S214).

(3) The Operation for Having a Content Played Back by the Mobile Phone 400

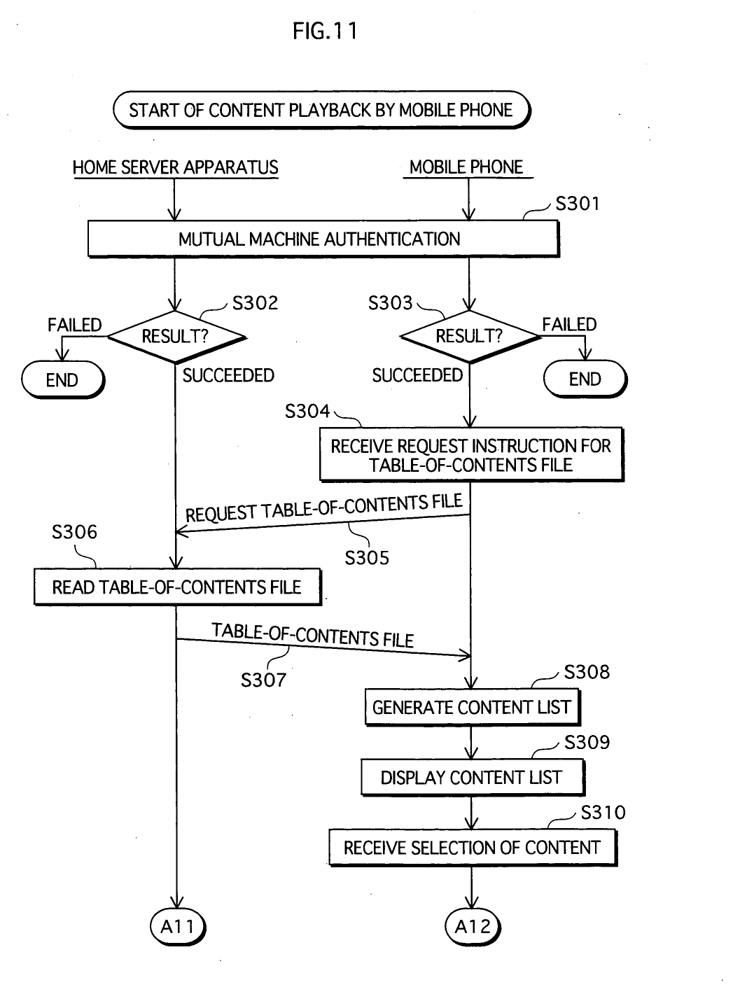

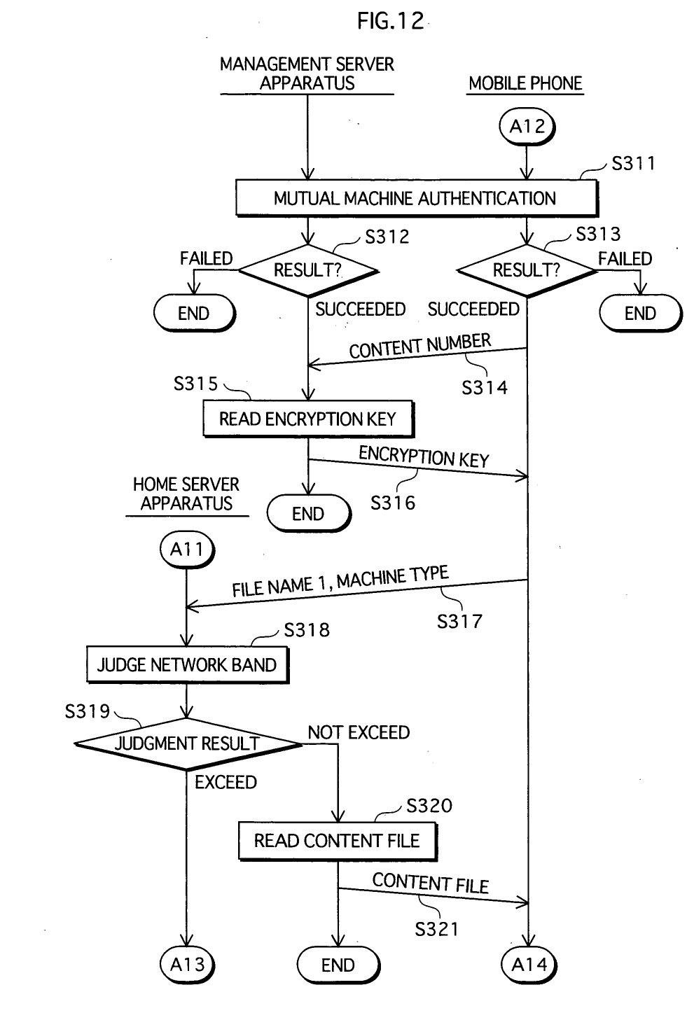

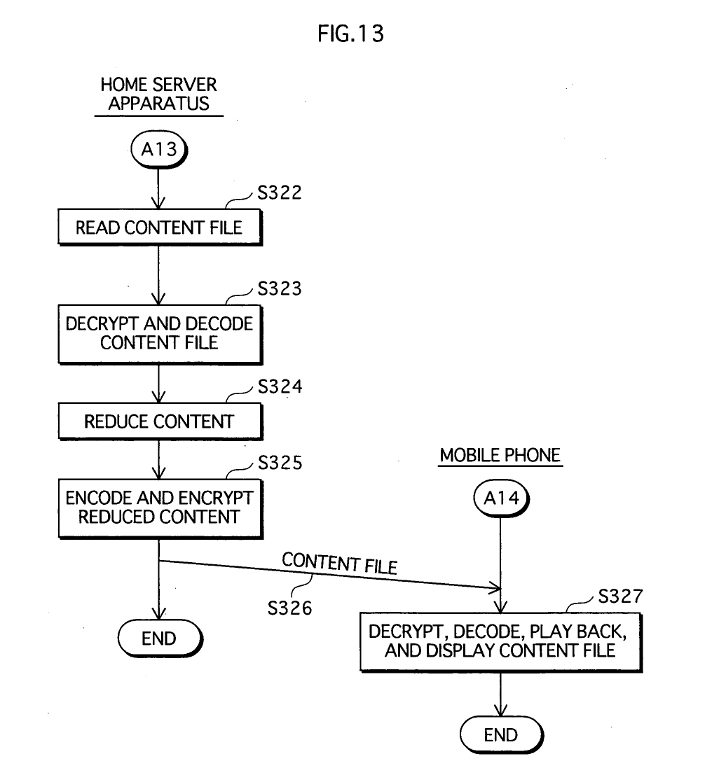

The following describes the operation for having a content played back by the mobile phone 400 with reference to the flow chart shown in FIGS. 11, 12 and 13.

The authenticating unit 208 in the home server apparatus 200 and the authenticating unit 404 in the mobile phone 400 perform machine authentication with each other (Step S301).

When the machine authentication has failed (Step S302, Step S303), the home server apparatus 200 and the mobile phone 400 cancel the processing thereafter.

When the machine authentication has been successfully performed (Step S302, Step S303), the controlling unit 406 receives a request resulting from a user operation from the inputting unit 411, the request requesting that a table-of-contents file be transmitted (Step S304), and transmits the request to the home server apparatus 200 via the communication controlling unit 403, the wireless communicating unit 402, the antenna 401, the wireless base station 12, the mobile phone network 11, and the Internet 10 (Step S305).

The controlling unit 204 reads the table-of-contents file 273 from the DVD 270 via the drive unit 201, and extracts one or more pieces of table-of-contents information that each include an encryption key, out of the pieces of table-of-contents information included in the read table-of-contents file (Step S306), and transmits the extracted pieces of table-of-contents information, as a table-of-contents file newly generated, to the mobile phone 400 via the communicating unit 209, the Internet 10, the mobile phone network 11, and the wireless base station 12(Step S307).

Next, the controlling unit 406 generates a content list using the received table-of-contents file (Step S308). The displaying unit 410 displays the content list (Step S309). The controlling unit 406 then receives a content number that identifies a content selected by the user from the inputting unit 411 (Step S310).

Next, the authenticating unit 106 in the management server apparatus 100 and the authenticating unit 404 in the mobile phone 400 perform machine authentication with each other (Step S311).

When the machine authentication has failed (Step S312, Step S313), the management server apparatus 100 and the mobile phone 400 cancel the processing thereafter.

When the machine authentication has been successfully performed (Step S312, Step S313), the controlling unit 406 transmits the received content number to the management server apparatus 100 via the communication controlling unit 403, the wireless communicating unit 402, the antenna 401, the wireless base station 12, the mobile phone network 11, and the Internet 10 (Step S314).

The controlling unit 104 reads an encryption key that corresponds to the received content number from the content characteristic information table 121 (Step S315), and transmits the read encryption key to the mobile phone 400 via the communicating unit 105, the Internet 10, the mobile phone network 11, and the wireless base station 12 (Step S316).

Further, the controlling unit 406 reads the machine type from the information storing unit 405, and transmits the read machine type and the extracted file name 1 to the home server apparatus 200 via the communication controlling unit 403, the wireless communicating unit 402, the antenna 401, the wireless base station 12, the mobile phone network 11, and the Internet 10 (Step S317).

The controlling unit 204 makes judgment on the band of the network using the received machine type (Step S318). When the bit rate 1 does not exceed the limit band (Step S319), the controlling unit 204 reads a content file identified with the file name 1 (Step S320), and transmits the read content file to the mobile phone 400 via the communicating unit 209, the Internet 10, the mobile phone network 11, and the wireless base station 12, with the use of the streaming technique (Step S321).

When the bit rate 1 exceeds the limit band (Step S319), the decrypting decoding unit 205 reads a content file identified with the file name 1 (Step S322), generates a decrypted content by decrypting the read content file using the received encryption key, and generates a content by decoding the generated decrypted content (Step S323). The encoding unit 207 generates a reduced content by reducing the received content (Step S324), generates a content file by encoding the reduced content and further performing encryption using the encryption key (Step S325). The encoding unit 207 then transmits the generated content file to the mobile phone 400 via the communicating unit 209, the Internet 10, the mobile phone network 11, and the wireless base station 12, with the use of the streaming technique (Step S326).

The decoding unit 407 decrypts the content file using the encryption key received from the management server apparatus 100 and generates a content by decoding the decrypted content file. The AV generating unit 408 generates video signals and audio signals. The displaying unit 410 displays visuals, and the speaker 409 outputs audio (Step S327).

3. Summary

As explained so far, according to the present invention, when a content is directly played back on a display apparatus connected to a home server machine, it is possible to play back the content in high quality, which is compressed with a high bit rate, whereas when a content is played back on a client machine connected via a home network, it is possible to play back the content without problems by transmitting, with the use of the streaming technique, the content with a low bit rate, which is transmittable without delay even in a band of a home network.

### 4. OTHER MODIFICATION EXAMPLES

Although the present invention has been explained so far according to the embodiment above, the present invention is not limited to the aforementioned embodiment, needless to say. The following cases are also included in the present invention:
(1) In the embodiment above, it is described that the contents and the table-of-content file are stored in an optical disc such as a DVD; however, the invention is not limited to optical disc media.

It is acceptable if the contents are stored in the built-in hard disk in the home server apparatus 200. When the contents are broadcasted by digital broadcasting, it is acceptable to receive a content and use the received content by recording it on the hard disk.

(2) In the embodiment above, it is described that the content numbers, content names, file names, bit rates, compression methods, encryption keys, and compression information file names are recorded on the table-of-contents file recorded on the DVD; however, it is acceptable if other data are also stored therein.

Further, in the embodiment above, the numbers of pictures, the numbers of bytes, and the addresses are written in the compression information file; however, it is also acceptable if information with respect to complexity of compression of image data is recorded in addition.

(3) In the embodiment above, it is arranged so that, in a case where a content is received from the home server apparatus 200 and played back on the personal computer 300, the content to be played back does not include one that is encrypted; however, the present invention is not limited to this arrangement.

It is acceptable if the personal computer 300 decrypts an encrypted content using an encryption key.

It is also acceptable to have an arrangement wherein, in a case where contents are transmitted from the home server apparatus 200 to the personal computer 300, all the contents are encrypted before being transmitted, in view of protection of the copyright. In such a case, the personal computer 300 decrypts all the encrypted contents.

In this arrangement, the home server apparatus 200 securely transmits the encryption key to the personal computer 300. For example, the home server apparatus 200 obtains in advance a public key for the personal computer 300 according to a public key encryption method, encrypts the encryption key using the public key, and transmits the encrypted encryption key to the personal computer 300. The personal computer 300 decrypts the encrypted encryption key using a secret key that is secretly stored in the personal computer 300 and corresponds to the public key, so as to generate an encryption key and use the generated encryption key.

Further, in the embodiment above, it is described that the mobile phone 400 obtains an encryption key from the management server apparatus 100; however, it is also acceptable if the mobile phone 400 obtains an encrypted encryption key from the management server apparatus 100.

Furthermore, in the embodiment above, it is described that the mobile phone 400 obtains an encryption key from the management server apparatus 100; it is also acceptable if, as mentioned above, the mobile phone 400 securely obtains the encryption key from the home server apparatus 200.

(4) In the embodiment above, it is described that the communication between the home server apparatus 200 and the personal computer 300 is performed with the use of a communication protocol such as TCP/IP; however, it is acceptable to additionally use an SAC (Secure Authenticated Channel) such as SSL in view of protection of the copyright.

With this arrangement, it is possible to prevent valuable contents from being wiretapped or tampered on the network paths. Further, by utilizing the function of machine authentication of the SAC, it is possible to transmit contents exclusively to client machines in the home network.

Likewise, in the embodiment above, it is described that the communication between the mobile phone 400 and the management server 100 is performed with the use of a communication protocol such as TCP/IP; however, it is acceptable to additionally use an SAC (Secure Authenticated Channel) such as SSL in view of protection of the copyright.

With this arrangement, it is possible to prevent information such as a credit card number required for purchase or important information such as a decryption key for a content from being wiretapped or tampered on the network paths. Further, by utilizing the function of machine authentication of the SAC, it is acceptable to transmit a decryption key exclusively to a specific mobile phone 400.

(5) In the embodiment above, it is described that the compression information file is recorded separately from the content data; however, it is also acceptable if the compression information file is stored in a same file in which the content data is stored.

(6) In the embodiment above, it is described that when a request for an encryption key is made to the management server apparatus 100, the management server apparatus 100 transmits an encryption key by return unconditionally; however, it is also acceptable if the management server apparatus 100 performs a fee-charging process for the content that corresponds to the encryption key to be transmitted, in response to the request for having the encryption key transmitted.

In addition, in a case where the content distribution system is in a form in which the usage right of contents are managed by the management server apparatus 100, it is acceptable that, when a request for having an encryption key transmitted is made, user authentication or machine authentication of the client machine being the request source is performed, so that the encryption key is transmitted by return according to the usage right to which the user or the machine is entitled after the authentication is performed successfully.

With this arrangement, it is possible to eliminate unauthentic machines and users, as well as to eliminate use by users who have not purchased the usage right of the contents.

(7) It is also acceptable to consider that the present invention provides methods as described above. It is further acceptable to consider that the present invention provides a computer program for realizing the methods with the use of a computer, or digital signals converted from the computer program.

Additionally, it is acceptable to consider that the present invention provides a computer-readable recoding medium e.g. a flexible disk, a hard disk, a CD-ROM, an MO, a DVD, a DVD-ROM, a DVD-RAM, a BD (Blu-ray Disc), and a semiconductor memory, that records such a computer program or such digital signals thereon; or to consider that the present invention provides such a computer program or such digital signals recorded on such a recording medium.

Further, it is possible to consider that in the present invention, such a computer program or such digital signals are transmitted via telecommunication lines, wireless or wired communication lines, or a network such as the Internet.

Moreover, it is possible to consider that the present invention provides a computer system comprising a microprocessor and a memory, wherein the memory stores the computer program therein, and the microprocessor operates according to the computer program.

Furthermore, it is possible that another independent computer system executes the program or the digital signals that are transferred on the recording media, or via the network mentioned above.

(8) Additionally, it is possible to combine any of the embodiment and the modifications mentioned above.

4. Advantageous Effects of the Invention

As explained so far, the present invention provides a content distribution system including a server apparatus and a playback apparatus that are connected with each other via a network, wherein (i) the server apparatus comprises: a receiving unit operable to receive a playback request for requesting that a content be played back by one of the server apparatus and the playback apparatus; a judging unit operable to judge which of the server apparatus and the playback apparatus is to play back the content; an obtaining unit operable to, (a) when the judging unit has judged that the server apparatus is to play back the content, obtain high quality data which is generated by encoding the content so as to render high quality and (b) when the judging unit has judged that the playback apparatus is to play back the content, obtain standard quality data which is generated by encoding the content so as to render standard quality; a first playback unit operable to, when the judging unit has judged that the server apparatus is to play back the content, play back the obtained high quality data; and a transmitting unit operable to, when the judging unit has judged that the playback apparatus is to play back the content, transmit the obtained standard quality data via the network, and (ii) the playback apparatus comprises: a reception unit operable to receive the standard quality data; and a second playback unit operable to decode and play back the received standard quality data.

With this arrangement, it is possible to judge which of the server apparatus and the playback apparatus connected via the network is to playback the content indicated in a playback request, so that in a case where the judgment result shows that the content is to be played back by the playback apparatus, standard quality data, which is the content being encoded so as to render standard quality, is transmitted to the playback apparatus connected via the network. Thus, it is possible to transmit the content via the network without delay.

The present invention further provides an arrangement wherein the obtaining unit includes: a storing medium that stores therein the high quality data and the standard quality data; and a reading unit operable to, (i) when the judging unit has judged that the server apparatus is to play back the content, read the high quality data from the storing medium and (ii) when the judging unit has judged that the playback apparatus is to play back the content, read the standard quality data from the storing medium.

With this arrangement, the storing medium stores therein the standard quality data and the high quality data; therefore, the server apparatus is able to obtain the high quality data without fail.

The present invention further provides an arrangement wherein the stored standard quality data is generated by encoding the content so as to render standard quality and further encrypting the encoded content, and the playback apparatus decrypts the standard quality data.

With this arrangement, the standard quality data is generated by encrypting the content, and the playback apparatus decrypts the standard quality data; therefore, it is possible to ensure security in transmission of the content.

The present invention further provides an arrangement wherein the obtaining unit includes: a storing medium that stores therein the high quality data; and a reading/generating unit operable to, (i) when the judging unit has judged that the server apparatus is to play back the content, read the high quality data from the storing medium and (ii) when the judging unit has judged that the playback apparatus is to playback the content, read the high quality data from the storing medium and generate the standard quality data by encoding the high quality data so as to render standard quality.

With this arrangement, the server apparatus generates the standard quality data from the high quality data; therefore, the playback apparatus is able to obtain the standard quality data without fail.

Further, it is acceptable to have an arrangement wherein the obtaining unit includes: a storing medium that stores therein the high quality data and compression information related to encoding of the high quality data; and a reading/generating unit operable to, (i) when the judging unit has judged that the server apparatus is to play back the content, read the high quality data from the storing medium, and (ii) when the judging unit has judged that the playback apparatus is to play back the content, read the high quality data and the compression information from the storing medium and generate the standard quality data by encoding the high quality data using the compression information so as to render standard quality.

With this arrangement, the server apparatus generates the standard quality data from the high quality data using the compression information; therefore, it is easy to generate the standard quality data.

### INDUSTRIAL APPLICABILITY

The present invention can be utilized operationally, that is repeatedly and continually, in the industry that manufactures and sells (i) server apparatuses for distributing digitalized productions such as music, movies, and novels recorded on recording media and (ii) playback apparatuses such as personal computers, mobile phones, and the like for playing back those productions.

1. A content distribution system including a server apparatus and a playback apparatus that are connected with each other via a network, wherein
(i) the server apparatus comprises:
a receiving unit operable to receive a playback request for requesting that a content be played back by one of the server apparatus and the playback apparatus;
a judging unit operable to judge which of the server apparatus and the playback apparatus is to play back the content;
an obtaining unit operable to, (a) when the judging unit has judged that the server apparatus is to play back the content, obtain high quality data which is generated by encoding the content so as to render high quality and (b) when the judging unit has judged that the playback apparatus is to play back the content, obtain standard quality data which is generated by encoding the content so as to render standard quality;
a first playback unit operable to, when the judging unit has judged that the server apparatus is to play back the content, play back the obtained high quality data; and
a transmitting unit operable to, when the judging unit has judged that the playback apparatus is to play back the content, transmit the obtained standard quality data via the network, and
(ii) the playback apparatus comprises:
a reception unit operable to receive the standard quality data; and
a second playback unit operable to decode and play back the received standard quality data.

2. The content distribution system of claim 1, wherein
the obtaining unit includes:
a storing medium that stores therein the high quality data and the standard quality data; and
a reading unit operable to, (i) when the judging unit has judged that the server apparatus is to play back the content, read the high quality data from the storing medium and (ii) when the judging unit has judged that the playback apparatus is to play back the content, read the standard quality data from the storing medium.

3. The content distribution system of claim 2, wherein
the stored standard quality data is generated by encoding the content so as to render standard quality and further encrypting the encoded content, and
the second playback unit decrypts, decodes, and plays back the standard quality data.

4. The content distribution system of claim 1, wherein
the obtaining unit includes:
a storing medium that stores therein the high quality data; and
a reading/generating unit operable to, (i) when the judging unit has judged that the server apparatus is to play back the content, read the high quality data from the storing medium and (ii) when the judging unit has judged that the playback apparatus is to play back the content, read the high quality data from the storing medium and generate the standard quality data by encoding the high quality data so as to render standard quality.

5. A server apparatus connected to a playback apparatus via a network, comprising:
a receiving unit operable to receive a playback request for requesting that a content be played back by one of the server apparatus and the playback apparatus;
a judging unit operable to judge which of the server apparatus and the playback apparatus is to play back the content;
an obtaining unit operable to, (i) when the judging unit has judged that the server apparatus is to playback the content, obtain high quality data which is generated by encoding the content so as to render high quality and (ii) when the judging unit has judged that the playback apparatus is to play back the content, obtain standard quality data which is generated by encoding the content so as to render standard quality;
a playback unit operable to, when the judging unit has judged that the server apparatus is to play back the content, play back the obtained high quality data; and
a transmitting unit operable to, when the judging unit has judged that the playback apparatus is to play back the content, transmit the obtained standard quality data via the network.

6. The server apparatus of claim 5, wherein
the obtaining unit includes:
a storing medium that stores therein the high quality data and the standard quality data; and
a reading unit operable to, (i) when the judging unit has judged that the server apparatus is to play back the content, read the high quality data from the storing medium and (ii) when the judging unit has judged that the playback apparatus is to play back the content, read the standard quality data from the storing medium.

7. The server apparatus of claim 6, wherein
the stored standard quality data is generated by encoding the content so as to render standard quality and further encrypting the encoded content, and
the playback apparatus decrypts the standard quality data.

8. The server apparatus of claim 7, wherein
the stored standard quality data is generated by performing encryption with an encryption key,
the storing medium stores therein the encryption key,
the transmitting unit further transmits the encryption key, and
the playback apparatus further receives the encryption key and decrypts the standard quality data with the encryption key.

9. The server apparatus of claim 5, wherein
the obtaining unit includes:
a storing medium that stores therein the high quality data; and
a reading/generating unit operable to, (i) when the judging unit has judged that the server apparatus is to play back the content, read the high quality data from the storing medium and (ii) when the judging unit has judged that the playback apparatus is to play back the content, read the high quality data from the storing medium and generate the standard quality data by encoding the high quality data so as to render standard quality.

10. The server apparatus of claim 5, wherein
the obtaining unit includes:
a storing medium that stores therein the high quality data and compression information related to encoding of the high quality data; and
a reading/generating unit operable to, (i) when the judging unit has judged that the server apparatus is to play back the content, read the high quality data from the storing medium, and (ii) when the judging unit has judged that the playback apparatus is to play back the content, read the high quality data and the compression information from the storing medium and generate the standard quality data by encoding the high quality data using the compression information so as to render standard quality.

11. The server apparatus of claim 10, wherein
the reading/generating unit generates the content from the high quality data and generates the standard quality data by encoding the generated content so as to render standard quality.

12. The server apparatus of claim 11, wherein
the content includes a plurality of frame images formed into groups,
the high quality data stored in the storing medium is made up of as many pieces of partial high quality data as the groups, the pieces of partial high quality data having been generated by encoding the frame images in each of the groups that correspond to the pieces of partial high quality data, respectively,
the compression information stored in the storing medium includes, for each of the groups, a data amount of partial high quality data and a number of frames included in the group, and
the reading/generating unit generates the standard quality data using the data amount and the number of frames included in the compression information for each of the groups.

13. The server apparatus of claim 12, wherein
the reading/generating unit generates the standard quality data so that a group formation of the high quality data conforms to a group formation of the standard quality data.

14. The server apparatus of claim 10, wherein
the reading/generating unit generates the content from the high quality data and generates the standard quality data by encoding and encrypting the generated content so as to render standard quality.

15. A content distribution method to be used by a server apparatus connected to a playback apparatus via a network, the content distribution method comprising:
a receiving step of receiving a playback request for requesting that a content be played back by one of the server apparatus and the playback apparatus;
a judging step of judging which of the server apparatus and the playback apparatus is to play back the content;
an obtaining step of, (i) when the judging step has judged that the server apparatus is to play back the content, obtaining high quality data which is generated by encoding the content so as to render high quality and (ii) when the judging step has judged that the playback apparatus is to playback the content, obtaining standard quality data which is generated by encoding the content so as to render standard quality;
a playback step of, when the judging step has judged that the server apparatus is to play back the content, playing back the obtained high quality data; and
a transmitting step of, when the judging step has judged that the playback apparatus is to play back the content, transmitting the obtained standard quality data via the network.

16. A content distribution program to be used by a server apparatus connected to a playback apparatus via a network, the content distribution program comprising:
a receiving step of receiving a playback request for requesting that a content be played back by one of the server apparatus and the playback apparatus;
a judging step of judging which of the server apparatus and the playback apparatus is to play back the content;
an obtaining step of, (i) when the judging step has judged that the server apparatus is to play back the content, obtaining high quality data which is generated by encoding the content so as to render high quality and (ii) when the judging step has judged that the playback apparatus is to playback the content, obtaining standard quality data which is generated by encoding the content so as to render standard quality;
a playback step of, when the judging step has judged that the server apparatus is to play back the content, playing back the obtained high quality data; and
a transmitting step of, when the judging step has judged that the playback apparatus is to play back the content, transmitting the obtained standard quality data via the network.

17. The content distribution program of claim 16 being recorded on a program recording medium that is computer-readable.
